(19) United States
(12) Patent Application Publication
(10) Pub. No.: US 2011/0093619 A1
(43) Pub. Date: Apr. 21, 2011

(54) Synchronizing Tasks between Mobile Devices and Servers

(75) Inventor: Eric NELSON, Boise, ID (US)

(73) Assignee: iAnywhere Solutions, Inc., Dublin, CA (US)

(21) Appl. No.: 12/580,511

(22) Filed: Oct. 16, 2009

(51) Int. Cl. G06F 15/16

(52) U.S. Cl. 709/248; 709/203; 715/234

(57) ABSTRACT

A system, method, and computer program product are provided for synchronizing tasks between mobiles device without a native task applications, such as mobile devices running the iPhone operating system, and a server. The method synchronizes tasks between a mobile device and a server with a task application installed. The method receives a plurality of data fields associated with a task from the mobile device, stores the data fields in a database, and transforms the plurality data fields into a task record formatted according to the task application installed on the server. The method communicates the task record to the task application installed on the server. The method operates symmetrically to facilitate synchronization of new and updated tasks between a source and a target, wherein the source may be either a mobile device or a server, and wherein the target may be either a server or a mobile device.

### FIELD OF THE INVENTION

The present invention relates generally to mobile communications and, more particularly, to synchronizing tasks and associated data between mobile client devices and servers.

### BACKGROUND OF THE INVENTION

Backend systems have been developed to automate many business processes within the workplace. Simple business processes involving the creation of a task by a user, assignment, or delegation of the task to another user, such as a co-worker, and subsequently updating the task to indicate current status, are frequently automated by systems that allow users to create, assign, and update a task as the task life cycle progresses from creation to completion.

In many cases, these systems include backend servers hosting task applications. These task applications typically provide e-mails to indicate task creation, assignment, and task status changes within the system. For example, when a user creates and assigns a task, the system may dispatch an e-mail to the task assignee indicating that a new task has been created and assigned in the system. E-mails may also be dispatched when a task status is updated, such as when a task is completed. These e-mail messages may be delivered to a mobile device of the assignee and may include identifying details of the task. However, when task-related emails are delivered to a mobile device that lacks a native client for the task application, the recipient cannot readily update the task on the mobile device. Instead, the assignee must log on to a task application hosted on the backend server and use the appropriate user interface to update the task. Similarly, if a user of a mobile device without a native task application client wishes to create a new task, the user must log on to a task application hosted on a backend server in order to create the task.

Requiring direct access to a task application creates several drawbacks. Notable among these drawbacks is the difficulty of accessing the host backend server directly from a mobile device. This drawback makes collaboration between users difficult. Costly solutions require the development or procurement of dedicated client software on the mobile device to interface with the task application via direct access to the backend server.

Users of mobile devices without native task application clients often have no recourse other than to login from a workstation computer in order to directly access the task application. The inability to use mobile devices effectively to automate interaction with business process systems is inefficient. Accordingly, what is desired is a means to synchronize tasks between a task application on a backend server and a mobile device in an efficient and economical manner.

Despite advances in mobile technology, mobile devices typically have greater limitations on memory capacity, data storage capacity, central processing unit (CPU) capacity, and networkability than workstation computers. Due to these limitations, some mobile device operating platforms, such as the iPhone operating system developed by Apple Inc., lack native task applications and local task databases. Given the versatility of mobile devices, it is also desired to implement a means by which these mobile devices can interact with servers to synchronize tasks in the context of potentially intermittent, unreliable, occasionally-connected, or temporarily-unavailable networking capabilities.

### SUMMARY OF THE INVENTION

Embodiments of the invention include methods, systems, and computer program products for synchronizing tasks between mobile client devices and servers. The methods, systems, and computer program products operate asynchronously, which allows them to synchronize tasks on mobile client devices that are occasionally or intermittently connected to servers they are synchronizing with. The methods, computer program products, and systems operate symmetrically in that either a mobile device or a backend server hosting a task application can be used to instantiate (i.e., create) or update a task. The methods, systems, and computer program products initiate task synchronization by invoking a mobile office client that resides on a mobile device and a sync engine residing on a mobile office server. The task synchronization methods, systems, and computer program products serve as a mechanism to deliver new tasks and task updates between mobile devices and backend servers.

Embodiments of the invention include a method that synchronizes updated and new tasks data between a mobile device and a backend server by invoking a user interface (UI) that enables a user to instantiate a new task or update an existing task. The method comprises invoking a sequence of functions that convert and store the inputted task data in a local task database on the mobile device, transform the task data into an extensible markup language (XML) document, and route the XML document from the mobile device to a mobile office server. The method further comprises receiving the XML document at the mobile office server and invoking a sync engine to parse the XML document and store task attributes in a task database on the mobile office server. The method further comprises invoking an adaptor module to transform the XML document into a task formatted for a task application. The method routes the task to a backend server hosting the task application.

Embodiments of the invention additionally include a method that synchronizes new and updated tasks between a backend server hosting a task application and a mobile device by invoking the sequence of functions in reverse in order to route a new or updated task from a backend server to a mobile office server. The method comprises receiving the task at the mobile office server and invoking a sync engine to parse the task and store task attributes in a task database on the mobile office server. The method further comprises invoking an adaptor module to transform the received task into a XML document formatted for the mobile device. The method routes the XML document to a mobile device having a mobile office client and a UI capable of displaying the received task on the mobile device. The method further comprises parsing the XML document and storing task attributes in a task database on the mobile device.

Embodiments of the invention additionally include a computer-readable medium having computer-executable instructions stored thereon that, if executed by a computing device, cause the computing device to perform a method for synchronizing new and updated tasks between a mobile device and a backend server. The computer-executable instructions operate asynchronously and symmetrically to synchronize tasks between a mobile device running a mobile office client and a backend server via a mobile office server running a sync engine.

Embodiments of the invention include a system that synchronizes tasks between a backend server and a mobile device wherein the tasks are created or updated using a task application on a backend server. New and updated tasks are then sent from the backend server to a mobile office server. When the tasks are received on the mobile office server, the system invokes a sync engine module to store task data in a task database on the mobile office server. In an embodiment, the system comprises an adaptor module on the mobile office server configured to transform the task to an XML document that is formatted as a comment-type script language that can be read by mobile devices including, but not limited to, mobile devices running the iPhone operating system. The system queues the XML document for the mobile device. The system delivers the queued XML document to the mobile device when the mobile device is connected to the mobile office server. The system further comprises a mobile office client module on the mobile device configured to parse the XML document and store task data in a local task database on the mobile device. The system includes a UI on the mobile device to display task data from the local task database.

Embodiments of the invention additionally include a system that synchronizes tasks between a mobile device and a backend server. The system comprises an UI on the mobile device which enables a user to instantiate a new task or update an existing task. The system comprises a local task database on the mobile device adapted to store task data input into the UI. The system includes a mobile office client module configured to transform the task data on the mobile device into an XML document. The system queues the XML document for delivery to a mobile office server until the mobile device is connected to the mobile office server. The system further includes a sync engine module on the mobile office server configured to parse the XML document and populate a database on the mobile office server with task data. The system comprises an adaptor module configured to transform the XML document into a task to be delivered to the backend server.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the relevant art to make and use the invention.

FIG. 1 depicts a system for synchronizing tasks between a backend server and a mobile device, in accordance with an embodiment of the present invention.

FIG. 2 illustrates a modular view of a task synchronization system, in accordance with an embodiment of the present invention.

FIG. 3 is a flowchart illustrating steps by which a new or updated task is synchronized to a mobile device, in accordance with an embodiment of the present invention.

FIG. 4 is a flowchart illustrating steps by which a new or updated task is synchronized from the mobile device to a backend server, in accordance with an embodiment of the present invention.

FIG. 5 is a communication flow diagram illustrating communications between a backend server, a mobile office server, and the mobile device, in accordance with an embodiment of the present invention.

FIGS. 6-10 illustrates an exemplary graphical user interface (GUI), wherein pluralities of tasks can be instantiated, updated, and viewed on a mobile device, in accordance with an embodiment of the invention.

FIG. 11 depicts an example computer system in which the present invention may be implemented.

The present invention will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

### I. Introduction

The following detailed description of the present invention refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

It would be apparent to one of skill in the art that the present invention, as described below, can be implemented in many different embodiments of software, hardware, firmware, and/or the entities illustrated in the figures. Any actual software code with the specialized control of hardware to implement the present invention is not limiting of the present invention. Thus, the operational behavior of the present invention will be described with the understanding that modifications and variations of the embodiments are possible, given the level of detail presented herein.

The present invention relates to systems, methods, and computer program products for synchronizing tasks between mobile client devices and a backend server hosting a task application.

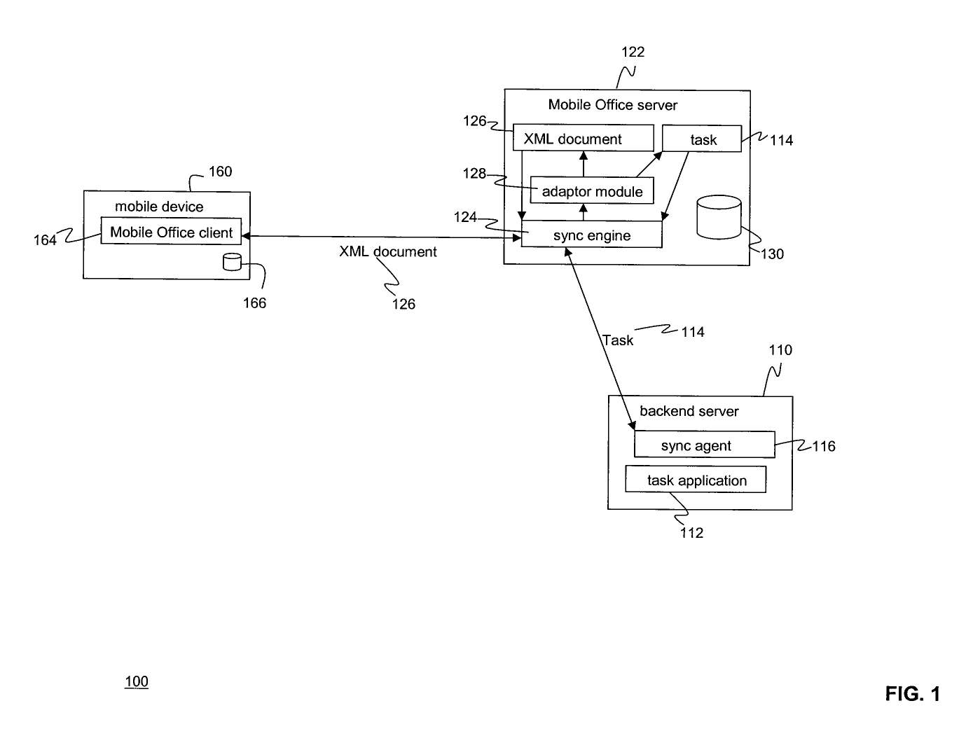

FIG. 1 is an example of a task synchronization system 100 including a backend server 110 with a task application. Although a single mobile device 160 is depicted in system 100, it is understood that a plurality of mobile devices 160 can access mobile office server 122 via a wireless network.

Traditionally, enterprise task applications, such as task application 112 are installed as ‘native’ or platform-dependent applications on dedicated enterprise servers such as backend server 110. Despite the usefulness of these task applications, it has been difficult to implement access to backend server 110 and related tasks 114 from mobile devices 160. Without a mobile device interface, users of mobile devices 160 must still return to the office to access task application 112 in order to view, edit, and create tasks 114. However, creating an interface to task application 112 residing on backend servers 110 has traditionally involved developing dedicated software for a mobile device platform, or including a native task application as part of a mobile device platform or operating system (OS). Enabling synchronization of tasks between mobile devices 160 to already-deployed mobile devices 160 increases the ease with which tasks representing business processes, appointments, meetings, and events can be created, assigned, and updated, as well as enabling teams of geographically dispersed users to more easily collaborate in order to complete tasks, among other benefits. Another advantage of embodiments of the present invention is that mobile devices 160 lacking native task applications can be used to view, update, and create tasks 114 via mobile office server 122.

As used herein, an application is any software program or web service that can be executed or run on a server, computer, or mobile client device. An application includes at least a rendering component, execution logic, and Input/Output (I/O) parameters. An application's execution logic may be in the form of binary executable code or scripting programming/markup languages such as HyperText Markup Language (HTML), Extensible HTML (XHTML), Java, JavaScript, or AJAX (Asynchronous JavaScript and XML). One of skill in the relevant arts will appreciate that other programming languages and technologies can be used for an application's execution logic. Examples of applications and software agents discussed herein include task application 112, sync agent 116, sync engine 124, adaptor module 128, and mobile office client 164.

Unless specifically stated differently, a user is interchangeably used herein to identify a human user, a software agent, or a group of users and/or software agents. Besides a human user who needs to synchronize tasks, a software application or agent sometimes needs to synchronize tasks. Accordingly, unless specifically stated, the term “user” as used herein does not necessarily pertain to a human being.

According to embodiments of the invention, tasks on mobile client devices are synchronized by calling or invoking symmetrical functions residing on servers and mobile devices.

The detailed description of embodiments of the present invention is divided into several sections. The first section describes a system for synchronizing tasks between mobile client devices and backend servers. Subsequent sections describe systems and methods for synchronizing tasks, including, but not limited to PIM tasks, between backend servers and mobile devices.

### II. Task Synchronization Systems

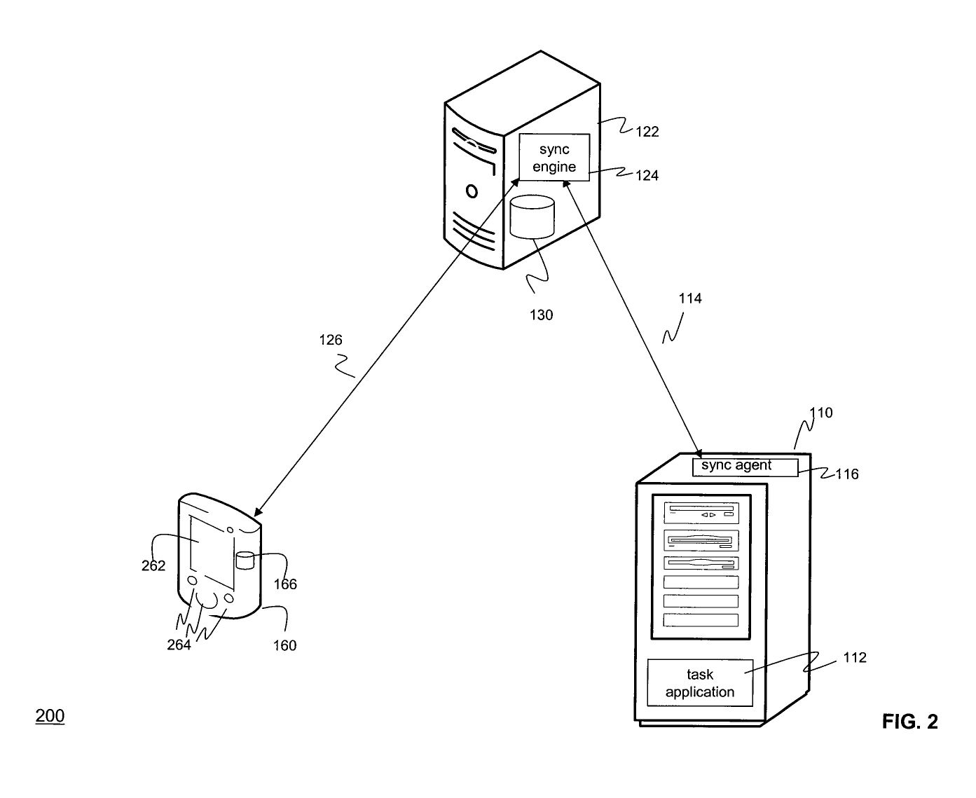

In the exemplary task synchronization systems 100 and 200 depicted in FIGS. 1 and 2, a task 114 from backend server 110, which has been updated or created using task application 112 and which is intended for mobile device 160, is detected by mobile office server 122 by sync engine 124. According to an embodiment of the invention, task 114 is a data record formatted according to task application 112. Then task 114 is passed on to adaptor module 128, in accordance with an embodiment of the present invention. In an embodiment, adaptor module 128 is configured to parse task 114 and store a plurality of task data fields in task database 130. In a further embodiment, adaptor module 128 is configured to transform task 114 from the task format used by task application 112 to an electronic document encoded in a markup language. In one embodiment, the markup language is an extensible markup language (XML) and adaptor module 128 is configured to transform task 114 to XML document 126. In another embodiment, adaptor module is further configured to transform an XML document 126 received from mobile office client 164 into a task 114 that can be read by task application 112 on backend server 110. In an embodiment of the invention, adaptor module 128 is configured to transform XML document 126 into a data record formatted according to task application 112 installed on backend server 110. In this way, adaptor module 128 can facilitate symmetrical task synchronization wherein mobile device 160 may be either the ‘target’ or ‘source’ for tasks to be synchronized with backend server 110. Similarly, backend server 110 can be either the source or target for new or updated tasks to be synchronized with mobile device 160.

According to an embodiment, mobile office server 122 may be one or more computers. In another embodiment, mobile office server 122 may be a virtual machine running on backend server 110. Conversely, the functionality of the backend server 110 may also be running on the mobile office server 122.

Sync engine 124 is configured to transmit XML document 126 to mobile device 160. Any existing method can be used for such transmission, including by way of example, and not limitation, methods detailed in “Synchronizing Communications and Data Between Mobile Devices and Servers,” U.S. patent application Ser. No. 12/104,905 to Jeide et al., Atty. Dkt. No. 1933.0530001, filed Apr. 17, 2008, which is incorporated herein by reference in its entirety.

Mobile device 160 may be one of many devices commonly designated as mobile clients, such as, but not limited to, personal digital assistants (“PDAs”), iPhones, iPod touch devices, devices operating according to the Microsoft Pocket PC specification with the Microsoft Windows® CE operating system (OS), devices running the Microsoft Windows® Mobile Standard OS, devices running the Microsoft Windows® Mobile Professional OS, devices running the Symbian OS, devices running the Palm OS®, mobile phones, BlackBerry® devices, smart phones, hand held computers, palmtop computers, laptop computers, ultra-mobile PCs, and other wireless mobile devices capable of running mobile applications.

As illustrated in FIG. 1, mobile device 160 may comprise a mobile office client 164 application and a local task data store or task database 166. As depicted in FIG. 2, mobile device 160 may further comprise a display 262 and an input device 264. Input device 264 can be used by a user of mobile device 160 to instantiate or create new tasks. Additionally, existing tasks 114 that have previously been synchronized to mobile device 160 as XML documents 126 can be displayed on display 262.

Sync engine 124 also allows mobile device 160 to receive the most current task data available on mobile office server 122. The current task data is sent to mobile device 160 as XML document 126. In an embodiment, mobile office client 164 comprises a client sync agent running on mobile device 160 which enables mobile device 160 to upload the most current task data to task database 130 on mobile office server 122 for any given task or set of tasks created or updated on mobile device 160. For example, a calendar application on mobile device 160 might allow other users to add or make changes to appointments which are then stored on mobile office server 122. A user of mobile device 160 may also have added, deleted, or made changes to appointments within mobile device 160 itself by using a user interface.

Upon synchronization, mobile office server 122 learns of the tasks and appointments (i.e., events) instantiated, changed, or deleted on mobile device 160, and mobile device 160 learns of tasks and events instantiated, changed, or deleted on backend server 110. In accordance with an additional embodiment of the present invention, a partial task synchronization is possible, whereby some subset of tasks and events may be exchanged between mobile office server 122 and mobile device 160. According to an embodiment, the subset of tasks are determined based upon criteria including, but not limited to, available memory on mobile device 160, available network bandwidth between mobile office server 122 and mobile device 160, central processing unit (CPU) speed on mobile device 160, available storage space in task database 166 on mobile device 160, and other factors. In an embodiment, the criteria or rules for determining which subset of tasks and events will be synchronized is stored in a data store or task database 130 on mobile office server 122. Although task database 130 is depicted in FIGS. 1 and 2 as being hosted locally on mobile office server 122, it is understood that task database 130 can be a remote database hosted on a separate database server (not shown) that is accessible by mobile office server 122.

In accordance with an embodiment, task data stored in database 130 hosted by mobile office server 122 may also be synchronized with local data stores or task databases 166 residing on mobile devices 160. “Data” as used herein may be any object, including, but not limited to, information in any form (text, images, video, audio, etc.) associated with tasks and events.

Systems 100 and 200 are commonly implemented within a persistent network connection over a cellular provider network, and communications of XML documents 126, tasks 114, and related e-mails may travel over the Internet. However, mobile device 160 may connect to mobile office server 122 by any communication means by which mobile office server 122, backend server 110, and mobile device 160 may interact, such as a docking cradle, Wide Area Network (WAN), Local Area Network (LAN), Wireless Local Area Network (WLAN), infrared, or Bluetooth. The degree of availability of access to the communication means employed may vary greatly, and users of mobile device 160 may go for days without synchronizing with mobile office server 122 or backend server 110, or may be able to synchronize constantly when connected to a WAN.

In a typical mobile environment such as mobile environment 100, multiple mobile devices 160 synchronize with one or more backend servers 110 via Mobile Office server 122. Mobile office server 122 and backend server 110 need not be a single physical computer, and may in fact comprise several computers distributed over a number of physical and network locations. For the purposes of illustration, Mobile Office server 122 and backend server 110 are depicted as single points of access in mobile environment 100. Mobile office server 122 and backend server 110 need not be separate physical computers either, and may in fact comprise a single computer as the functionality of Mobile office server 122 may be performed by a virtual machine running on backend server 110. Conversely, the functionality of backend server 110 may be performed by a virtual machine executing on mobile office server 122.

FIG. 2 depicts synchronization system 200 in which mobile device 160 is capable of synchronizing tasks with backend server 110 via mobile office server 122. FIG. 2 is described with continued reference to the embodiment illustrated in FIG. 1. However, FIG. 2 is not limited to that example embodiment. In accordance with an embodiment of the present invention, mobile office server 122 facilitates calls between sync engine 124 running on mobile office server 122 and mobile office client 164 comprising a client sync agent running on mobile device 160. In an embodiment, XML document 126 comprises task data fields that are encoded in a format readily understood by mobile office client 164. Sync engine 124 facilitates passing of task data and variables between mobile device 160 and mobile office server 122. In an embodiment, synchronization system 200 is operable to synchronize a task database 130 located at mobile office server 122 with a local data store or task database 166 located at mobile device 160. In another embodiment, task database 130 accessible from, but remote to mobile office server 122.

Task synchronization system 200 is operable to synchronize calendar entries, events, and appointments between backend server 110 and mobile device 160 via mobile office server 122. According to an embodiment of the invention, sync engine 124 facilitates function calls to adaptor module 128 hosted on mobile office server 122 in order to transform a new or updated task 114 received from sync agent 116 into XML document 126. In an embodiment, adaptor module 128 is comprised of functions that are called to parse task 114 into a plurality of data fields. By way of example and not limitation, task 114 may comprise the data fields listed in a C language header (.h) file below. The following code is an embodiment of the fields of a task. In this example embodiment (from an include file), a task can be an appointment such as meeting and other calendar entries. As would be appreciated by one of skill in the relevant arts, other programming languages and technologies can be used to implement the task data fields listed in the programming language code sample below.

/***********************************************************

| | | |
|---|---|---|
| * | Source File | : EDSFieldTypes.h |
| * | Description | : This header contains the defines for field types |

that can be contained in datastore objects.
*********************************************************/
#ifndef _{——}ESI_DSFIELDTYPES_H
#define _{——}ESI_DSFIELDTYPES_H
// Possible event types for an calendar item. This information would be part
of FLDID_EVENT_TYPE field
enum EVENT_TYPE
{

EVENT_TYPE_APPOINTMENT = 0,
EVENT_TYPE_EVENT,
EVENT_TYPE_ANNIVERSARY,
EVENT_TYPE_REMINDER,
EVENT_TYPE_MEETING_REQUEST,
EVENT_TYPE_UNKNOWN

};
// Type of a mail. This information would be part of FLDID_MAIL_INFO field

| | |
|---|---|
| #define EMAIL_TYPE_MEETING_REQUEST | 0x00010000 // a meeting request |
| #define EMAIL_TYPE_CANCELLED_MEETING | 0x00020000 // a cancelled meeting |

request
//MEETING_REQ_OPTION // Set by clients.

| | |
|---|---|
| #define MEETING_REQ_OPTION_SEND_UPDATES | 0x00000001 |

// the meeting request response status
typedef enum tagMRResponse { eInvalidMR = 0, eAcceptMR = 1, eDeclineMR = 2,
eTentativeMR = 3, eAcceptCancelledMR = 4 } MRResponse;
// Possible values for “BusyStatus” of calendar item. This information would
be part of FLDID_BUSY_STATUS field
// Note: These field defines are fixed to match the vCal spec, so don't
change them!!
enum BUSY_STATUS
{

BUSY_STATUS_BUSY = 0,
BUSY_STATUS_FREE = 1,
BUSY_STATUS_TENTATIVE = 2,
BUSY_STATUS_OUTOFOFFICE = 3

};
// Task priority values. These are part of FLDID_PRIORITY
enum TASK_PRIORITY
{

TASK_PRIORITY_NONE = 0,
TASK_PRIORITY_HIGHEST,
TASK_PRIORITY_MEDIUM,
TASK_PRIORITY_LOWEST

};
enum MEETING_REQ_ACTION
{

MR_ACTION_NONE = 0,
CREATE_MEETING,
UPDATE_MEETING

};
enum MEETING_ATTENDEE_STATUS
{

| | |
|---|---|
| MASNoResponse = 0, | // attendee has not yet responded to the meeting |

request (or status is unknown)

| | |
|---|---|
| MASAccepted = 1, | // attendee has accepted the meeting |
| MASDeclined = 2, | // attendee has declined the meeting |

| | |
|---|---|
| MASTentative = 3 | // attendee has tentatively accepted the meeting |

};
//Confidential type for Calendar and Tasks record.
enum CONFIDENTIAL_STATUS
{

NORMAL = 0,
PERSONAL,
PRIVATE,
CONFIDENTIAL

};
// these enums define the user's status in the meeting and are only sent from
// server to client. The client cannot change the values. If it's just a
regular
// appointment on the server, the status will be sent as Chair meaning that it
// is potentially OK for the client to add attendees.
enum CURRENT_USER_MEETING_STATUS
{

CU_MeetingStatus_Attendee = 0,
CU_MeetingStatus_Chair = 1

};
// Field groups

| | | |
|---|---|---|
| #define FLDGRP_CALENDAR | 0x01000000 | // Calendar fields |
| #define FLDGRP_TASK | 0x02000000 | // Task fields |
| #define FLDGRP_EMAIL | 0x03000000 | // Email fields |
| #define FLDGRP_CALL | 0x04000000 | // Call fields |
| #define FLDGRP_NOTEPAD | 0x05000000 | // Notepad fields |
| #define FLDGRP_EXPENSE | 0x06000000 | // Expense fields |
| #define FLDGRP_RECUR | 0x07000000 | // Recurring Fields |
| #define FLDGRP_DATABASE | 0x08000000 | // Database Fields |

// Common fields - These fields are valid in multiple database types

| | | |
|---|---|---|
| #define FLDID_CONFIDENTIAL_INTEGER | (FLDGRP_COMMON \| FLDTYPE_INTEGER | \| 1) |

// Shows if the record is confidential or not
//This field is a backward compatible field for confidential.

| | | |
|---|---|---|
| #define FLDID_CONFIDENTIAL_BOOLEAN | (FLDGRP_COMMON \| FLDTYPE_BOOLEAN | \| 1) |

// Shows if the record is confidential or not
//This field is a backward compatible field for confidential.

| | | |
|---|---|---|
| #define FLDID_CONFIDENTIAL_BOOLEAN | (FLDGRP_COMMON \| FLDTYPE_BOOLEAN | \| 1) |

// Shows if the record is confidential or not

| | | |
|---|---|---|
| #define FLDID_CATEGORIES | (FLDGRP_COMMON \| FLDTYPE_STRING | \| 2) |

// List of categories separated by ;

| | | |
|---|---|---|
| #define FLDID_NOTES | (FLDGRP_COMMON \| FLDTYPE_STRING | \| 3) |

// Detailed notes field

| | | |
|---|---|---|
| #define FLDID_ATTACHMENT | (FLDGRP_COMMON \| FLDTYPE_STRING | \| 4) |

// List of attachments stored as string field data (See ECAttachments)

| | | |
|---|---|---|
| #define FLDID_RECORD_ID | (FLDGRP_COMMON \| FLDTYPE_STRING | \| 5) |

// Represents record ids

| | | |
|---|---|---|
| #define FLDID_DB_FILE_NAME | (FLDGRP_COMMON \| FLDTYPE_STRING | \| 6) |

// Represents record ids
// Calendar fields

| | | |
|---|---|---|
| #define FLDID_CAL_SUBJECT | (FLDGRP_CALENDAR \| FLDTYPE_STRING | \| 1) |

// Brief subject/summary field

| | | |
|---|---|---|
| #define FLDID_CAL_LOCATION | (FLDGRP_CALENDAR \| FLDTYPE_STRING | \| 2) |
| #define FLDID_EVENT_TYPE | (FLDGRP_CALENDAR \| FLDTYPE_INTEGER | \| 3) |

// For possible values, refer EVENT_TYPE... constants

| | | |
|---|---|---|
| #define FLDID_BUSY_STATUS | (FLDGRP_CALENDAR \| FLDTYPE_INTEGER | \| 4) |

// For possible values, refer BUSY_STATUS... constants

| | | |
|---|---|---|
| #define FLDID_REQUIRED_ATTENDEES | (FLDGRP_CALENDAR \| FLDTYPE_STRING | \| 5) |

// List of attendees separated by “;”

| | | |
|---|---|---|
| #define FLDID_OPTIONAL_ATTENDEES | (FLDGRP_CALENDAR \| FLDTYPE_STRING | \| 6) |

// List of attendees separated by “;”

| | | |
|---|---|---|
| #define FLDID_START_DATETIME | (FLDGRP_CALENDAR \| FLDTYPE_TIME | \| 7) |

// The StartDate (and possibly time) of the calendar item

| | | |
|---|---|---|
| #define FLDID_DURATION | (FLDGRP_CALENDAR \| FLDTYPE_TIMESPAN | \| 9) |

// Duration of the appointment

| | | |
|---|---|---|
| #define FLDID_CAL_REMIND_ON | (FLDGRP_CALENDAR \| FLDTYPE_BOOLEAN | \| 10) |

// True if the reminder is on/enabled

| | | |
|---|---|---|
| #define FLDID_CAL_REMIND_OFFSET | (FLDGRP_CALENDAR \| FLDTYPE_TIMESPAN | \| 11) |

// The reminder offset from the start date

| | | |
|---|---|---|
| #define FLDID_CAL_REMIND_DESCRIPTION | (FLDGRP_CALENDAR \| FLDTYPE_STRING | \| |

12) // Description for Reminder

| | | |
|---|---|---|
| #define FLDID_MEETING_CHAIR | (FLDGRP_CALENDAR \| FLDTYPE_STRING | \| 13) |

// the meeting chair

| | | |
|---|---|---|
| #define FLDID_CAL_APPT_TZINFO | (FLDGRP_CALENDAR \| FLDTYPE_STRING | \| 14) |

// the meeting chair
//the following is defined in EMail section, but are also required for
calendar meeting records so they're here for a placeholder

| | | |
|---|---|---|
| //#define FLDID_XCS_MEETING_GUID | (FLDGRP_EMAIL \| FLDTYPE_STRING | \| |

20) // this is the XCS Sync GUID for the calendar record associated with the
meeting

| | | |
|---|---|---|
| //#define FLDID_MEETING_UID | (FLDGRP_EMAIL \| FLDTYPE_STRING | \| |

21) // the meeting unique luid. In Notes, the ApptUNID, in Exchange/CE, the
Schedule+ meeting ID tag

| | |
|---|---|
| #define FLDID_CAL_MEETING_REQ_ACTION (FLDGRP_CALENDAR \| FLDTYPE_INTEGER | \| |

15) // The action requested for meeting request. Normally client sends it.
Values. Look for Enum MEETING_REQ_ACTION for values

| | |
|---|---|
| //#define FLDID_CAL_MEETING_REQ_OPTION (FLDGRP_CALENDAR \| FLDTYPE_INTEGER | \| |

16) // The options for meeting request. Bit flags. Look for
MEETING_REQ_ACTION for values.

| | | |
|---|---|---|
| #define FLDID_REQ_ATTENDEE_STATUS | (FLDGRP_CALENDAR \| FLDTYPE_STRING | \| 17) |

// list of required attendee status enums converted to strings (see
groupware_field_mappings page on wiki for details)

| | | |
|---|---|---|
| #define FLDID_OPT_ATTENDEE_STATUS | (FLDGRP_CALENDAR \| FLDTYPE_STRING | \| 18) |

// list of optional attendee status enums converted to strings (see
groupware field mappings page on wiki for details)

| | |
|---|---|
| #define FLDID_CURRENT_USER_MEETING_STATUS | (FLDGRP_CALENDAR \| FLDTYPE_INTEGER |

| 19) // indicates the current user's status: attendee, chair, etc. Used to
help in knowing when to reschedule items. See CURRENT_USER_MEETING_STATUS
enum for values
// Task fields

| | | |
|---|---|---|
| #define FLDID_TASK_SUBJECT | (FLDGRP_TASK \| FLDTYPE_STRING | \| 1) |

// Brief subject/summary field

| | | |
|---|---|---|
| #define FLDID_DUE_DATE | (FLDGRP_TASK \| FLDTYPE_TIME | \| 2) |
| #define FLDID_TASK_START_DATE | (FLDGRP_TASK \| FLDTYPE_TIME | \| 3) |
| #define FLDID_COMPLETED | (FLDGRP_TASK \| FLDTYPE_BOOLEAN | \| 4) |
| #define FLDID_COMPLETION_DATE | (FLDGRP_TASK \| FLDTYPE_TIME | \| 5) |
| #define FLDID_PERCENT_COMPLETE | (FLDGRP_TASK \| FLDTYPE INTEGER | \| 6) |
| #define FLDID_ELAPSED_TIME | (FLDGRP_TASK \| FLDTYPE_TIMESPAN | \| 7) |
| #define FLDID_MILEAGE | (FLDGRP_TASK \| FLDTYPE_STRING | \| 8) |
| #define FLDID_BILLING_INFORMATION | (FLDGRP_TASK \| FLDTYPE_STRING | \| 9) |
| #define FLDID_PRIORITY | (FLDGRP_TASK \| FLDTYPE_INTEGER | \| 10) |

// For possible values, refer to TASK_PRIORITY... constants

| | | |
|---|---|---|
| #define FLDID_TASK_REMIND_ON | (FLDGRP_TASK \| FLDTYPE_BOOLEAN | \| 11) |

| | | |
|---|---|---|
| #define FLDID_TASK_REMIND_DATETIME | (FLDGRP_TASK \| FLDTYPE_TIME | \| 12) |
| #define FLDID_TASK_REMIND_DESCRIPTION | (FLDGRP_TASK \| FLDTYPE_STRING | \| 13) |

// Email database fields

| | | |
|---|---|---|
| #define FLDID_FROM | (FLDGRP_EMAIL \| FLDTYPE_STRING | \| 1) |
| #define FLDID_TO | (FLDGRP_EMAIL \| FLDTYPE_STRING | \| 2) |

// Recipient list of attendees separated by “;”

| | | |
|---|---|---|
| #define FLDID_CC | (FLDGRP_EMAIL \| FLDTYPE_STRING | \| 3) |

// Recipient list of attendees separated by “;”

| | | |
|---|---|---|
| #define FLDID_BCC | (FLDGRP_EMAIL \| FLDTYPE_STRING | \| 4) |

// Reciepient list of attendees separated by “;”

| #define FLDID_SENT_DATE | (FLDGRP_EMAIL \| FLDTYPE_TIME | \| 5) | |
|---|---|---|---|
| #define FLDID_RECEIVED_DATE | (FLDGRP_EMAIL \| FLDTYPE_TIME | \| 6) | |
| #define FLDID_SIZE | (FLDGRP_EMAIL \| FLDTYPE_INTEGER | \| 7) | |
| #define FLDID_MAIL_INFO | (FLDGRP_EMAIL \| FLDTYPE_INTEGER | \| 8) | // |

See MAIL_STATUS... attributes for possible values

| | | |
|---|---|---|
| #define FLDID_MAIL_ID | (FLDGRP_EMAIL \| FLDTYPE_STRING | \| 9) |

// Internet Mail Id.

| | | |
|---|---|---|
| #define FLDID_MAIL_SUBJECT | (FLDGRP_EMAIL \| FLDTYPE_STRING | \| 10) |

// Subject line of the message

| | | |
|---|---|---|
| #define FLDID_MAIL_SENTTO | (FLDGRP_EMAIL \| FLDTYPE_STRING | \| 11) |

// (palm) not sure what this is

| | | |
|---|---|---|
| #define FLDID_MAIL_REPLYTO | (FLDGRP_EMAIL \| FLDTYPE_STRING | \| 12) |

// RFC822 Reply-To

| | | |
|---|---|---|
| #define FLDID_BODY | (FLDGRP_EMAIL \| FLDTYPE_STRING | \| 13) |
| //#define FLDID_RIM_MSG_REF_ID | (FLDGRP_EMAIL \| FLDTYPE_INTEGER | \| 14) // |

Msg ID ref of RIM emails - not used anymore
// meeting request/response fields

| | | |
|---|---|---|
| #define FLDID_MR_SUBJECT | (FLDGRP_EMAIL \| FLDTYPE_STRING | \| 16) // |

the meeting request subject text

| | | |
|---|---|---|
| #define FLDID_MR_LOCATION | (FLDGRP_EMAIL \| FLDTYPE_STRING | \| 17) // |

the meeting request location

| | | |
|---|---|---|
| #define FLDID_MR_WHEN | (FLDGRP_EMAIL \| FLDTYPE_STRING | \| 18) // |

the meeting request When text (format undefined)

| | | |
|---|---|---|
| #define FLDID_MR_STATUS | (FLDGRP_EMAIL \| FLDTYPE_INTEGER | \| 19) // |

the meeting request/response accept/decline status, see tagMRResponse for
possible values

| | | |
|---|---|---|
| #define FLDID_MR_INBOXLUID | (FLDGRP_EMAIL \| FLDTYPE_STRING | \| 15) // If |

the email is a meeting request, this field contains the LUID of the request in
the server inbox. Devices should include this field in the outbox when
responding to meeting requests

| | | |
|---|---|---|
| #define FLDID_XCS_MEETING_GUID | (FLDGRP_EMAIL \| FLDTYPE_STRING | \| 20) // |

this is the XCS Sync GUID for the calendar record associated with the meeting.
Used to prevent duplication during sync. This is no longer used in Robie

| | | |
|---|---|---|
| #define FLDID_MEETING_UID | (FLDGRP_EMAIL \| FLDTYPE_STRING | \| 21) // |

the meeting unique luid. In Notes, the ApptUNID, in Exchange/CE, the
Schedule+ meeting ID tag
#endif //_{——}ESI_DSFIELDTYPES_H

As would be appreciated by one of skill in the relevant arts, some of the fields listed in the code sample above may be optional and therefore not be populated for all tasks 114 and for all varities of mobile devices 160. For example, in one embodiment of the present invention, mobile device 160 is a device running an iPhone operating system (OS) developed by Apple Inc. for the iPhone and iPod touch. In this exemplary embodiment, the only task data fields used are those listed in Table 1.

TABLE 1
Task Data Fields Synchronized to iPhone Devices

| Field Name | Description |
|---|---|
| FLDID_TASK_START_DATE | Task start date |
| FLDID_COMPLETION_DATE | Task completion date |
| FLDID_DUE_DATE | Task due date |
| FLDID_TASK_SUBJECT | Subject/title of task |
| FLDID_NOTES | Task notes - free form text |
| FLDID_COMPLETED | Task completion status |
| FLDID_CONFIDENTIAL_INTEGER | Unique identifier used to relate |
| | or tie a task to an task synchro- |
| | nization system record (i.e., an |
| | EDS record), not displayed on |
| | mobile device |
| FLDID_PRIORITY | Task priority (e.g., None, Low, |
| | Medium, High) |
| FLDID_CATEGORIES | Task category (e.g., business, |
| | personal, recurring) |

The task 114 is then synchronized to mobile device 160 by passing XML document 126 from mobile office server 122 to mobile office client 164.

When a user instantiates or creates a new task or event on mobile device 160, mobile office client 164 running on mobile device 160 is operable to transform the task data inputted or edited on mobile device 160 into an XML document 126. XML document 126 is sent to sync engine 124 on mobile office server 122. After the new or updated task is received at mobile office server 122, it is delivered to server sync agent 128 on backend server 110 via interface 232.

Sync engine 124 calls sync agent 116 that interfaces with backend server's 110 personal information manager (PIM) provider. In accordance with an embodiment of the invention, the PIM provider may be one of many applications commonly designated enterprise task applications 112, such as, but not limited to, Microsoft Outlook, Microsoft Exchange, Lotus Domino, and Novell GroupWise. Backend server 110 may be one or more of a Microsoft Exchange server, a Lotus Domino server, a Lotus Notes server, and a Novell GroupWise server.

In an embodiment, sync agent 116 that is a local object resident on backend server 110 uses a local NM data store to read and write data to task application 112, and the backend server's 110 sync agent 116 is notified of task changes by a local listener resident on backend server 110. When sync agent 116 is notified of a change in a task made in task application 112, it notifies sync engine 124 of the change by forwarding the changed task 114 to mobile office server 122. From there, sync engine 124 calls adaptor module 128 to transform task 114 to XML document 126 and relays XML document 126 to mobile office client 164 that is participating in the synchronization via sync engine 124 on mobile office server 122. According to an embodiment of the invention, sync engine 124 is notified of new task creation or task updates occurring in task application 112 by a listener resident on mobile office server 122 and when sync engine 124 detects a task to be synchronized, sync engine invokes adaptor module 128 to transform task 114 into XML document 126.

Server sync agent 128 and mobile office client 164 work in conjunction with each other to exchange XML documents 126 encoded in a comment-type language that can be used to insert, update, and/or delete tasks, events, and calendar records. In accordance with an embodiment of the invention, the syntax of XML document 126 is depicted below:

<?xml version=“1.0” encoding=“us-ascii” ?>

| | |
|---|---|
| − | <XMLRec Version=“2”> |
| | <Fields>100100011~01200000A1~1320000041~0400100020~4001000310~test |

notes4200000116~Task from
device520000029~20090805Z520000039~20090803Z520000050~</Fields>

</XMLRec>

### III. Task Synchronization Methods

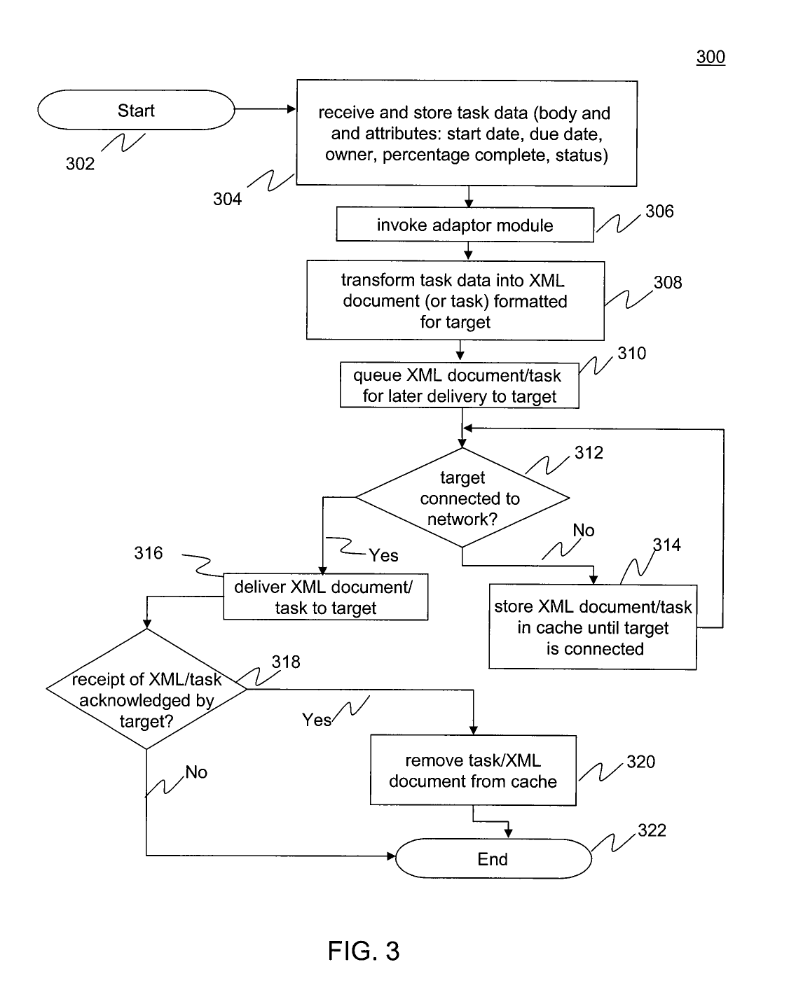

FIG. 3 is a flowchart 300 illustrating steps by which a synchronization method is used to synchronize tasks and events between a backend server and a mobile device, in accordance with an embodiment of the present invention.

More particularly, flowchart 300 illustrates the steps by which the synchronization of a new or updated task between a task application on a backend server and a mobile client device is performed, according to an embodiment of the present invention. According to an embodiment, the ‘new’ task can be one or more of a new, updated, and a deleted task. In an embodiment, the task being synchronized can be one or more of an appointment, a calendar entry, a meeting request, and a business process task. The synchronization method synchronizes tasks between a source system and a target system. As the synchronization method is symmetrical, a mobile client device may be either the source of or the target for task to be synchronized. Similarly, a backend server running a task application can be the source of or the target for a task to be synchronized. According to an embodiment of the present invention, the target and source systems are either a mobile client device or a server. For example, the target and source systems can be either a mobile client device or a backend server. FIG. 3 is described with continued reference to the embodiments illustrated in FIGS. 1 and 2. However, FIG. 3 is not limited to those embodiments. Note that the steps in the flowchart do not necessarily have to occur in the order shown.

The method begins at step 302 and proceeds to step 304 where task data is received from the source. As noted above, the source may be either mobile device 160 or backend server 110. In an embodiment of the invention, data is received at mobile office server in step 304. After receipt of the task data, the method proceeds to step 306.

In step 306, adaptor module 128 is invoked to transform the task data received in step 304. According to an embodiment, step 306 comprises determining, by adaptor module 128 the target platform for the task data received in step 304. In an embodiment, adaptor module determines the target based upon the task data received from the source in step 304. Once the determination of the target platform is made, the method proceeds to step 308.

In step 308, if it was determined in step 306 that the received task data needs to be synchronized to a mobile device 160, adaptor module 128 converts the received data into XML document 126 and the method proceeds to step 310. Alternatively, if it was determined in step 306 that the received task data needs to be synchronized to backend server 110, adaptor module 128 converts the received data into task 114.

In step 310, the task 114 or XML document 126 is queued for delivery to the target system. As the task synchronization method is symmetrical, mobile device 160 may be either the source of or the target for the task data received in step 304.

In step 312, an evaluation is made regarding whether the target involved in the task synchronization is offline. For example, if the target is a mobile device 160, it may be offline due to a temporary lack of network connectivity, being turned off, or due to being rebooted by a user. If the target is backend server 110, it may be temporarily offline due to a scheduled shutdown (i.e., for scheduled server maintenance or for a software patch, upgrade, or install being performed on task application 112) or due to an unscheduled reboot/restart. If it is determined that the target is offline, control is passed to step 314. If it is determined that the target is online, then control is passed to step 316.

In step 314, in an embodiment, task information is saved in a cache on mobile office server 122 while the target is offline. According to an embodiment, the task information (either a task 114 or an XML document 126) may be saved in task database 130 on mobile office server 122. In an embodiment, control is passed back to step 312 to determine if the target is still offline based on detection of an event, such as receipt of communications from the target. In an alternative embodiment, control is passed back to step 312 at a timed interval that is tunable by an administrator on mobile office server 122. In another embodiment, the interval varies based on factors including one or more of the number of tasks queued in the cache, the type of task synchronizations to be carried out (i.e., task creation, task update, task delete) in the cache, the characteristics (i.e., memory size, CPU speed, storage capacity, network connectivity) of the target, and other factors.

In step 316, one or more queued tasks 114 or XML documents 126, depending on the target platform, are delivered to the target. This step is performed after the target is online. After sending the task or XML document to the online target, control is passed to step 318.

In step 318, an evaluation is made regarding whether the receipt of task data delivered in step 316 have been acknowledged by the target. If it is determined that the target has acknowledged receipt of the task data, control is passed to step 320. If it is determined that the target has not acknowledged receipt of the task data, then control is passed to step 322 where the method ends. In an embodiment, delivered, but unacknowledged task data remains in the mobile office server 122 cache and is marked or flagged as delivered, but unacknowledged.

In step 320, delivered task data which has been acknowledged by the target is removed from the mobile office server 122 cache and control is passed to step 322 where the method ends.

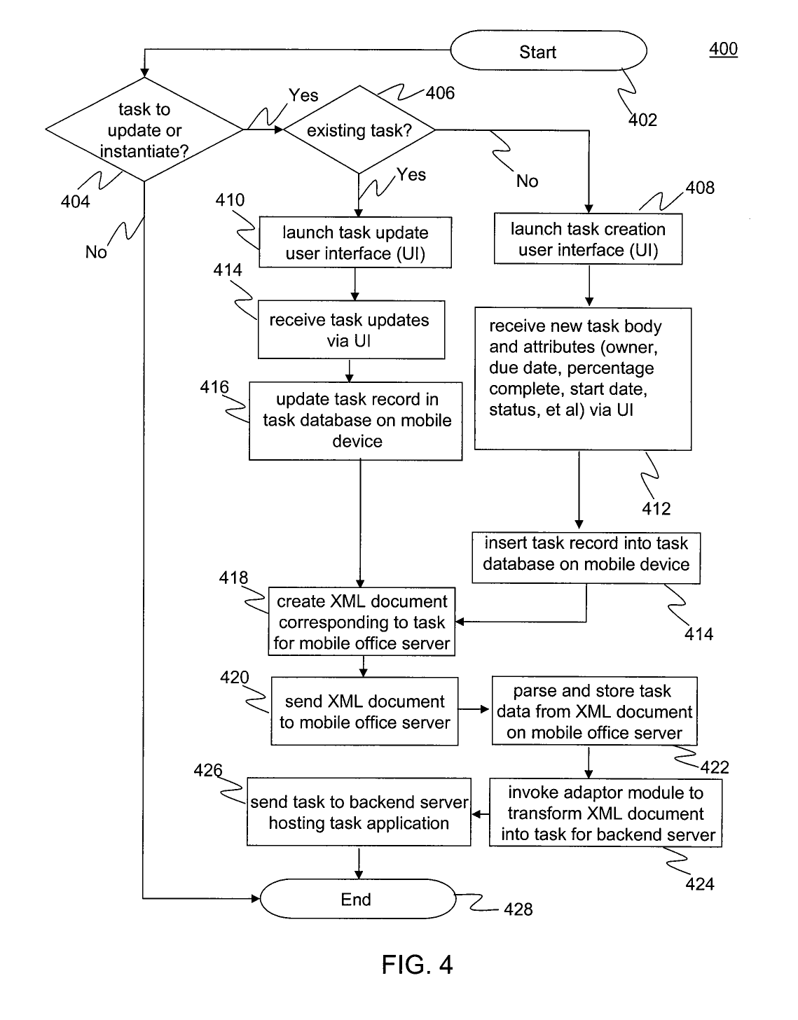

FIG. 4 is a flowchart 400 illustrating steps by which new and updated tasks are synchronized between a mobile device and a server such as a backend server hosting a task application, in accordance with an embodiment of the present invention.

More particularly, flowchart 400 illustrates the steps by which the synchronization method for new tasks, including new, updated, and deleted calendar entries, appointments, meeting requests, and tasks related to business processes is performed, according to an embodiment of the present invention. The synchronization method synchronizes multiple tasks between a source system and a target system. The method also handles cases where a new task to be synchronized is subsequently modified before the synchronization occurs. FIG. 4 is described with continued reference to the embodiments illustrated in FIGS. 1-4. However, FIG. 4 is not limited to those embodiments. Note that the steps in flowchart 400 do not necessarily have to occur in the order shown.

The method begins at step 402 and proceeds to step 404 where an evaluation is made regarding whether a user is requesting, via input device 264, to update or instantiate a new task on mobile device 160. In step 404, the desire to update or create a task is indicated via input into a user interface (UI) displayed on display 262. If it is determined that a task update or instantiation is to be performed, control is passed to step 406. If it is determined that no task needs to updated or instantiated, then control is passed to step 428 where the method ends.

In step 406, determination is made, based on input received via the UI displayed in display 262, whether the user of mobile device 160 is updating an existing task or instantiating (i.e., creating) a new task. If the received user input indicates that a new task is to be created, control is passed to step 408. If the received user input indicates that an existing task is to be updated, control is passed to step 410.

In step 408, a task creation UI is launched on mobile device 160 and control is passed to step 412.

In step 412, new task attributes, or data field values are received. In an embodiment, the task data field values are input by a user using input device 264 to interact with the task creation UI displayed in display 262. According to an embodiment, the new task data fields include, but are not limited to task owner, task due date, task start date, and completion status. In other embodiments, the new task data fields include the data fields listed in Table 1 in section II above.

The method continues in step 414 where a new task record is inserted into task database 166 on mobile device 160. After the new task record is inserted, control is passed to step 418.

In step 410, a task edit UI is launched on mobile device 160 and control is passed to step 416 where one or more data fields for the task are updated in local task database 166 on mobile device 160. In an embodiment, step 416 comprises updating one or more of the data fields listed in Table 1. According to an embodiment, a user of mobile device 160, uses input device 264 to interact with the task edit UI displayed on display 262. After all task updates are completed, control is passed to step 418.

In step 418, XML document 126 is created by invoking mobile office client 164, wherein XML document 126 is encoded to represent each task updated or created on mobile device 160 since the last task synchronization. In this way, multiple tasks to be synchronized to backend server 110 can be transmitted together in a ‘batch’ mode in a single XML document to mobile office server 122. In an alternative embodiment, updated or newly-created tasks are converted into separate XML documents 126 for sequential transmission to mobile office server 122 as each task is individually updated or created. After one or more XML documents 126 are created, control is passed to step 420 where mobile office client 164 sends one or more XML documents 126 to mobile office server 122.

The method continues in step 422 where sync engine 124 on mobile office server 122 parses the XML document(s) and stores task data extracted from the XML document(s). In an embodiment of the present invention, the task data is stored in task database 130 on mobile office server 122. After the task data is parsed and stored, control passes to step 424.

In step 424, adaptor module 128 is invoked to transform XML document(s) 126 into a task 114 formatted for task application 112 on backend server 110. According to an embodiment of the invention, adaptor module 128 is implemented as software code executing on mobile office server 122. After the transformation of XML document 126 into task 114 is complete, control is passed to step 426 where task 114 is sent to backend server 110 hosting task application 112. In an embodiment, task 114 is received by sync agent 116 on backend server 110. According to an embodiment, in step 424 sync agent 116 passes an newly created task 114 on to task application 112 and task 114 is in sync with a task created on mobile device 160 in steps 412 and 414. Similarly, if an existing task was updated on mobile device 160 in steps 414 and 416, sync agent 116 passes updated task 114 on to task application 112 as part of step 424 so that the updated task is in sync with the corresponding task on mobile device 160. The method ends at step 428.

### IV. Task Synchronization Sequences

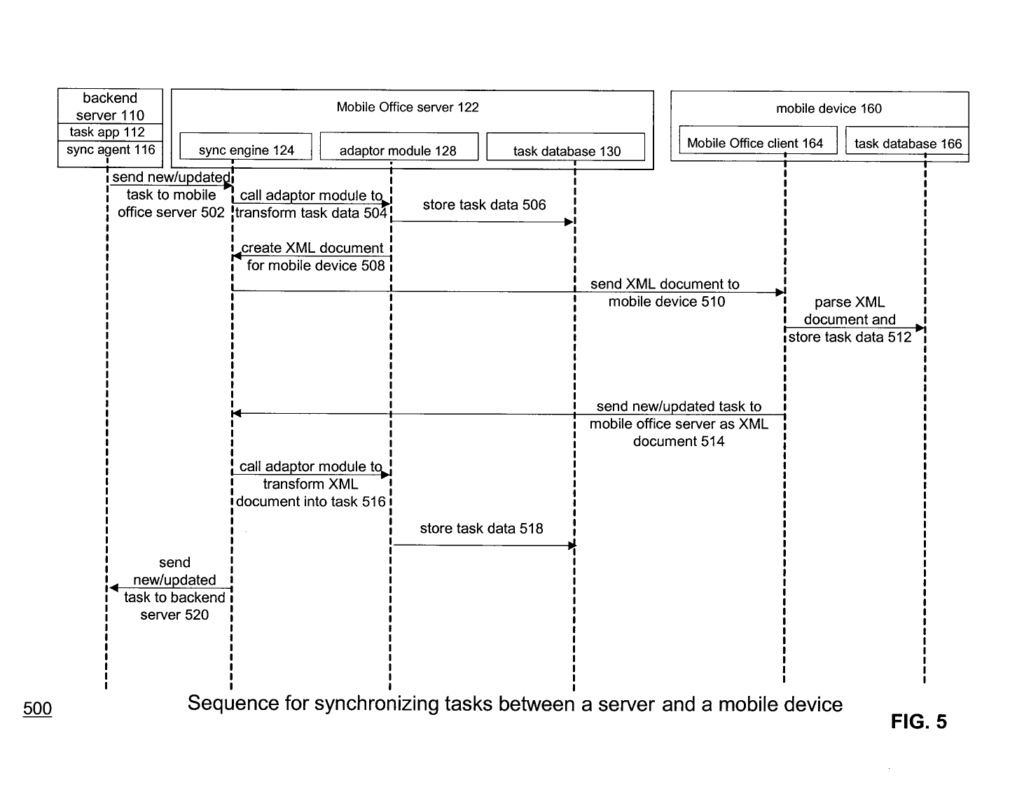

FIG. 5 is a communication flow diagram 500 illustrating communications between backend server 110, mobile office server 122, and mobile device 160, in accordance with an embodiment of the present invention. FIG. 5 is described with continued reference to the embodiments illustrated in FIGS. 1-4. However, FIG. 5 is not limited to those embodiments.

Communication flow diagram 500 depicts the communication sequence of steps 502-512 that occurs when a task is updated or created on backend server 110 and is subsequently synchronized to mobile device 160, in accordance with an embodiment of the invention. Beginning with step 514, communication flow diagram 500 further depicts the sequence of communications that occurs when a new or updated task from mobile device 160 is synchronized to backend server 110 via mobile office server 122.

In step 502, a new or updated task is sent from backend server 110 to sync engine 124 on mobile office server 122. According to an embodiment, step 502 is carried out by sync agent 116 on backend server 110. In this embodiment, after a task 114 is updated or created in task application 112, sync agent 116 sends task 114 to mobile office server 122. In an embodiment, sync engine 124 detects a new or updated task 114, and in response to receiving task 114, calls adaptor module 128 in step 504. In an embodiment, multiple new or updated tasks 114 can be sent to mobile office server 122 in batch mode in step 502. In an alternative embodiment, separate new or updated tasks are sent to mobile office server 122 sequentially.

In step 504, adaptor module 128 parses task(s) 114 and transforms data communicated with task(s) 114. In step 506, task data parsed by adaptor module 128 is stored in task database 130. In step 508, in response to being invoked in step 504, adaptor module 128 creates XML document 126. In an embodiment, XML document 126 is encoded in step 508 with task data corresponding to multiple new or updated tasks. Alternatively, a separate XML document 126 is created for each sequential new or updated task 114 received from backend server 110 in step 502.

In step 510 XML document 126 is transmitted from sync engine 124 to mobile office client 164. In step 512, in response to receiving XML document 126, mobile office client 164 parses XML document 126 and stores task data in local task database 166 on mobile device 160. At this point, the new (or updated) task 114 created (or edited) via task application 112 on backend server 110 is synchronized to mobile device 160. In accordance with an embodiment, a user of mobile device 160 will be able to view, using input device 264 and display 262, at least a subset of the task data previously created (or updated) on backend server 110.

When a new task is instantiated on mobile device 160, the communications sequence described above occurs in reverse. In this way, task synchronization between mobile devices and backend servers is handled in a symmetrical manner. In step 514, a communication flow corresponding to a communications sequence wherein mobile device 160 is the source of a new or updated task to be synchronized to backend server 110. In response to a creation or update of a task on mobile device 160, a new or updated task is transformed into an XML document 126 and communicated to sync engine 124 on mobile office server 122. According to an embodiment of the invention, multiple new or updated tasks can be encoded in XML document 126 as part of step 514, thus facilitating transmission of task data in batch mode to mobile office server 122. Alternatively, XML document 126 may contain task data corresponding to a single task creation or update performed on mobile device 160.

In step 516, in response to receipt of XML document 126, sync engine 124 calls adaptor module 128 to parse task data from XML document 126 and transforms XML document 126 into one or more tasks 114. In step 518, task data parsed by adaptor module 128 is stored in task database 130.

In step 520, one or more new or updated tasks 114 resulting from the transformation in step 516 are communicated to backend server 110. In an embodiment, sync engine 124 transmits task(s) 114 to sync agent 116 on backend server 110, which in turn passes task(s) 114 on to task application 112. At this point, the new (or updated) task created (or edited) via a UI displayed on display 262 on mobile device 160 is synchronized to backend server 110. In accordance with an embodiment, a user of task application 112 will be able to view the task data previously created (or updated) on mobile device 160.

### V. Example Mobile Device User Interface

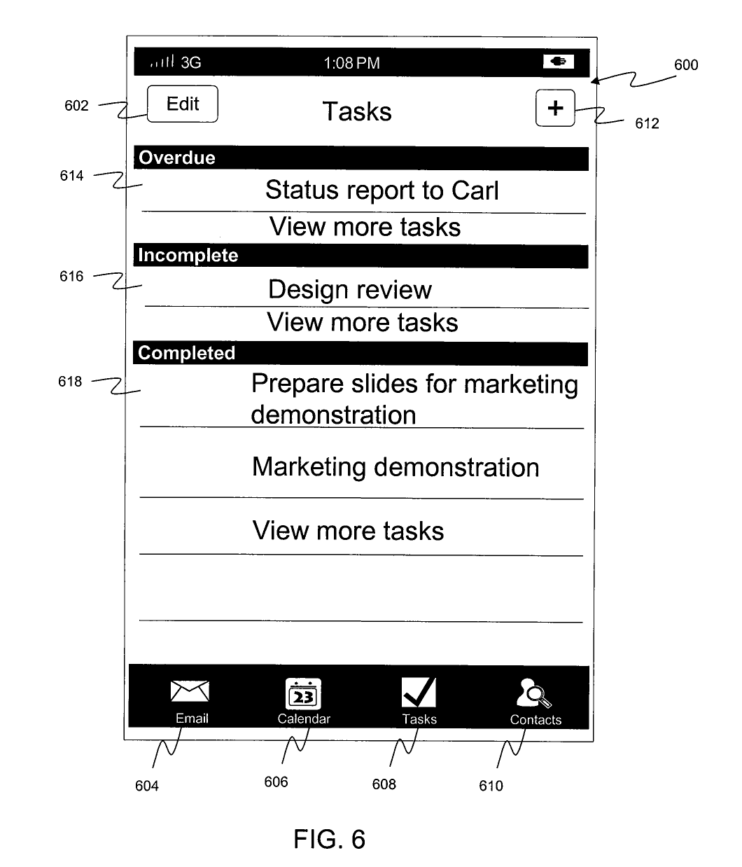

FIGS. 6-10 illustrate a graphical user interface (GUI), according to an embodiment of the present invention. The GUI depicted in FIGS. 6-10 is described with reference to the embodiments of FIGS. 1-5. However, the GUI is not limited to those example embodiments. For example, the GUI may be the task creation UI used to instantiate new tasks, as described in steps 408 and 412 above with reference to FIG. 4. The GUI may also be the task update UI used to update existing tasks as described in steps 410 and 414 above with reference to FIG. 4. In an embodiment of the invention, the GUI illustrated in FIGS. 6-10 is displayed on mobile device 160 having display 262.

Although in the exemplary embodiments depicted in FIGS. 6-10 the GUI is shown as an mobile device interface running in an iPhone OS, it is understood that the GUI can be readily adapted to execute on a display of other mobile device platforms and operating systems, a computer terminal, a mobile office server display, a backend server console, or other display of a computing device.

Throughout FIGS. 6-10, displays are shown with various icons, command regions, buttons, and data entry fields, which are used to initiate action, invoke routines, launch displays, enter data, view data, or invoke other functionality. The initiated actions include, but are not limited to viewing tasks, instantiating a new task by inputting task data, and updating a task. For brevity, only the differences occurring within the figures, as compared to previous or subsequent ones of the figures, are described below.

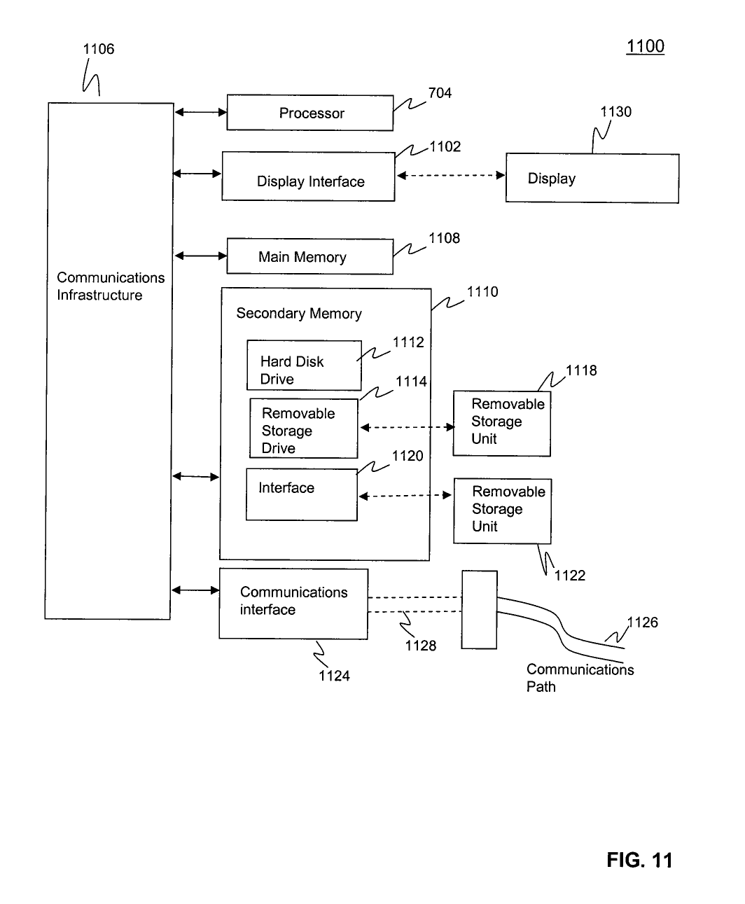

FIG. 6 illustrates an exemplary tasks interface 600, wherein pluralities of tasks can be displayed by a user in command regions 614, 616, and 618 in order to enable the user to view overdue, incomplete, and complete tasks, respectively, in accordance with an embodiment of the invention. In an embodiment, a system for task synchronization includes tasks interface 600 and also includes an input device, such as input device 264, which is configured to allow a user to display and enter data among respective portions of tasks interface 600. For example, through moving a pointer or cursor on tasks interface 600 within and between each of the command regions 614, 616, and 618 displayed in a display, a user can display and edit one or more tasks to be synchronized by the system. In an embodiment, the display may be a computer display 1130 shown in FIG. 11, and tasks interface 600 may be display interface 1102. According to embodiments of the present invention, input device 264 can be, but is not limited to, for example, a touch screen, a keyboard, a pointing device, a track ball, a touch pad, a joy stick, a voice activated control system, or other input devices used to provide interaction between a user and tasks interface 600.

FIG. 6 illustrates how a user can view one or more overdue tasks in command region 604. Overdue tasks can be viewed in command region 614. In an embodiment, overdue tasks are incomplete tasks whose due date has passed. For example, command region 614 displays tasks not marked as completed that exceed the end date or due date assigned to the tasks. In the example embodiment depicted in FIG. 6, a single overdue task with the title ‘Status report to Carl’ is displayed in command region 614. However, as would be appreciated by one of skill in the relevant arts, multiple tasks can be displayed in each of command regions 614, 616, and 618. In embodiments of the invention, other task data fields besides the task title can be displayed in command regions 614, 616, and 618. For example, in alternative embodiments tasks interface 600 may display task start date(s), due date(s), and/or owner(s) in addition to the task title(s). In accordance with an embodiment, the tasks displayed within command regions 614, 616, and 618 may be sorted according to one or more of due date, start date, and priority. In one embodiment, sorting of tasks displayed in tasks interface 600 may be changeable by a user of mobile device 160 in an administrative interface (not shown). In an alternative embodiment, the sorting of tasks displayed in tasks interface 600 may be changed in an administrative interface (not shown) on mobile office server 122 or within task application 112 on backend server 110.

Incomplete tasks can be viewed in command region 616. According to an embodiment, incomplete tasks are tasks not yet marked as complete. For example, command region 616 displays tasks not marked as completed that are still prior to their assigned due data or end date. In the example embodiment depicted in FIG. 6, a single incomplete task with the title ‘Design review’ is displayed in command region 616.

Completed tasks can be displayed in command region 618. In an embodiment, completed tasks are tasks marked as completed by a user. Alternatively, command region 618 displays tasks whose percentage complete is set to 100%. In the example embodiment depicted in FIG. 6, two completed tasks are displayed in command region 618.

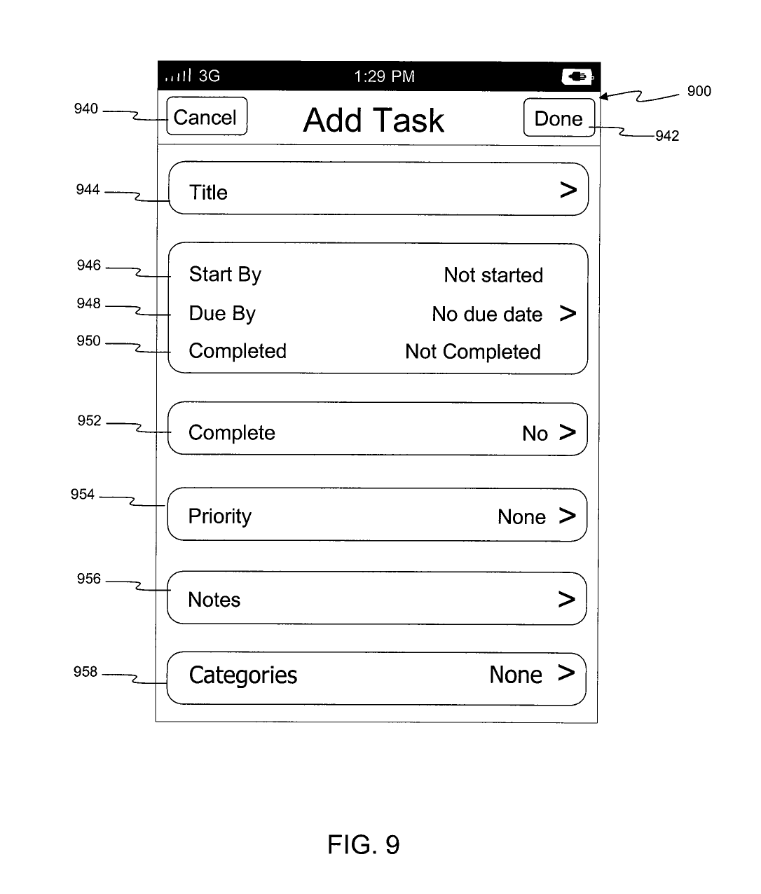

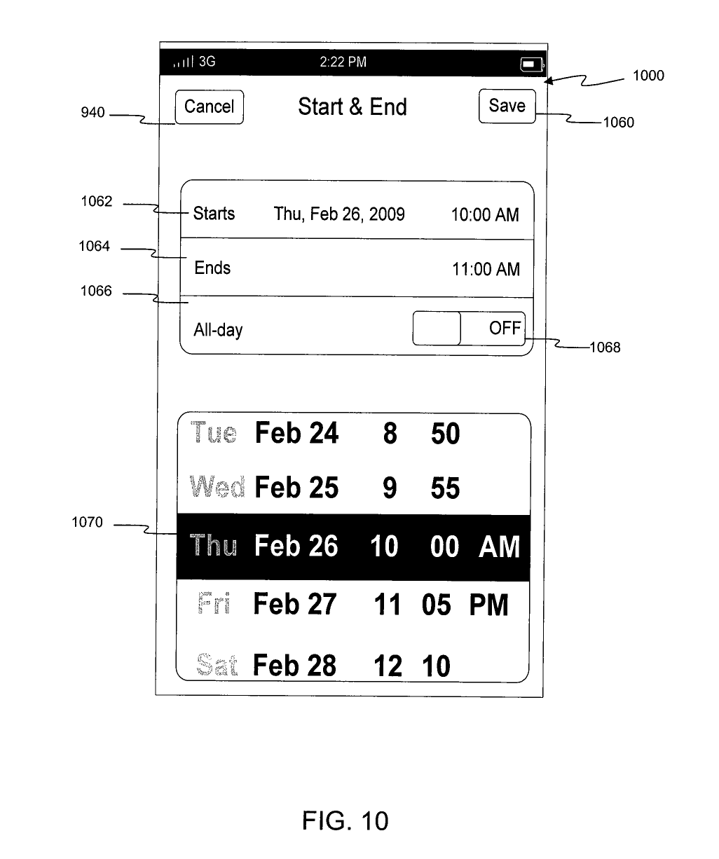

By selecting, using input device 264, one or more displayed tasks in conjunction with selecting or ‘tapping’ edit button 602, a user can edit tasks displayed in command regions 614, 616, and 618. According to an embodiment of the invention, selection of edit button 602 launches the display of interface 1000 described with reference to FIG. 10 below. Add icon 612 may be selected to add a new task. In an embodiment, selection of add icon 612 launches the display of add task interface 900 described with reference to FIG. 9 below. Task button 608 can be selected or ‘tapped’ to return to interface 600 after editing of adding a task.

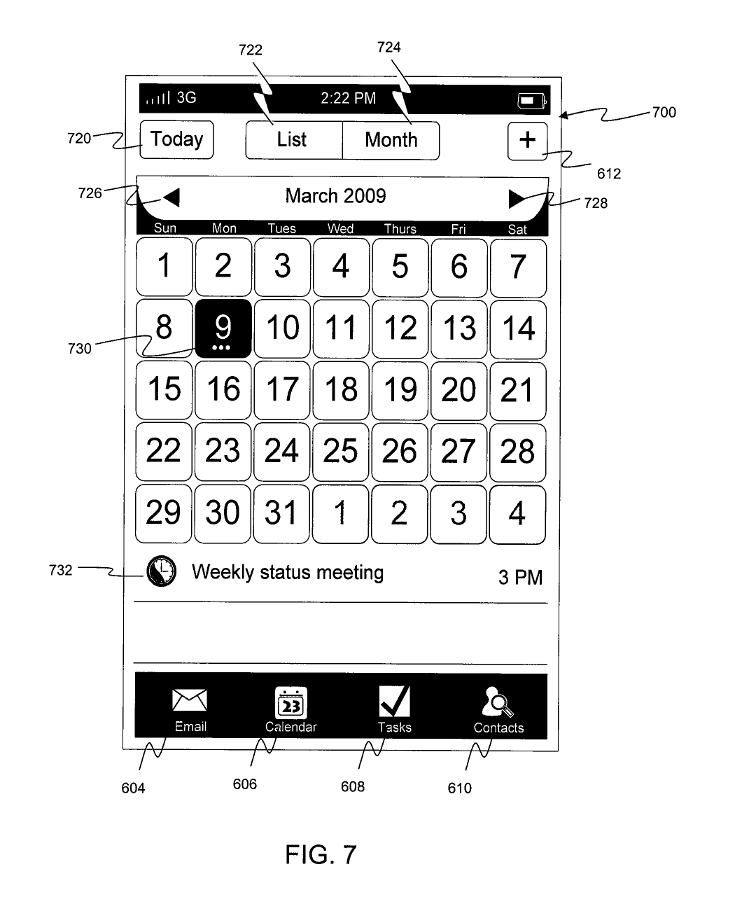

In the example embodiment depicted in interface 600, icons 604, 606, and 610 can be used to launch interfaces for e-mail, calendar, and contact applications, respectively. For example, a user can select email icon 604 to launch an e-mail interface (not shown) for viewing task-related e-mail messages. In an embodiment of the invention, selection of calendar icon 606 launches the display of interface 700 described with reference to FIG. 7 below. A user can select contacts icon 610 to launch a PIM contact-management interface (not shown).

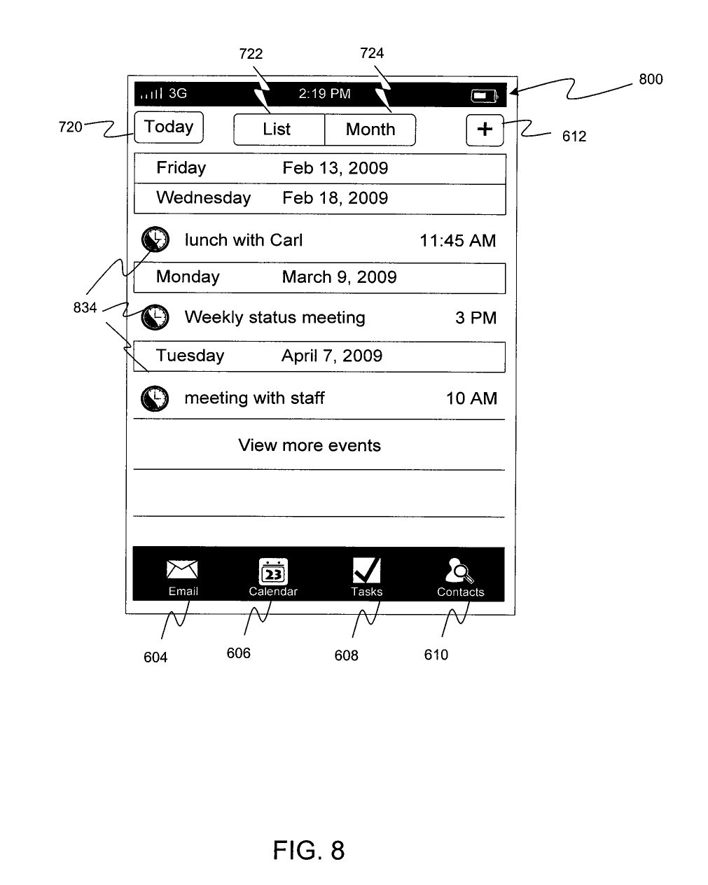

FIG. 7 illustrates an exemplary interface 700, wherein pluralities of planned tasks such as meetings and appointments can be displayed by a user in command regions 730 and 732, in accordance with an embodiment of the invention. According to an embodiment, a user can display his/her calendar in month view depicted in interface 700 by selecting month button 724. Alternatively, a user can display his/her calendar in a list view by selecting list button 722. In an embodiment, selection of list button 722 launches interface 800, which is described with reference to FIG. 8 below. By selecting list button 722 or month button 724, a user can switch between interface 700 and interface 800.

Using input device 264, a user can select or tap Today button 720 to display one or more events 732 occurring in the current day. Alternatively, a user can select a day 730 within interface 700 to display the day's events 732. As illustrated in FIG. 7, days displayed in interface 700 having at least one scheduled event are indicated with an ellipses below the date number, in accordance with an embodiment.

Using input device 264, a user can select or tap back arrow 726 to see a previous month or forward arrow 728 to see a subsequent month in interface 700.

A user can select add icon 612 to create a new event. Within interface 700, a user can create a new event for a given day by first selecting Month button 724 and either back button 726 or forward button 728 to navigate to the desired month. Then, a user can select a day 730 the new event is to occur within interface 700. After selecting a day, the user can select add icon 612 to add an event for the selected day. In an embodiment, after selecting a day, the user selects the duration (i.e., start and end time) via start and end interface 1000, which is described with reference to FIG. 10 below.

FIG. 8 illustrates an exemplary interface 800 for displaying a list of all existing events 834 scheduled on a user's calendar. As explained above with reference to FIG. 7, today button 720 can be selected in interface 800 to display the current day's tasks and Month button 724 can be selected to return to month display illustrated in FIG. 7.

FIG. 9 depicts add task interface 900 for instantiating a new task on mobile device 160. Using input device 264, a user can interact with add task interface 900 to instantiate, or create a new task. According to an embodiment, add task interface 900 may also be the task creation UI used to create tasks as described in steps 408 and 412 above with reference to FIG. 4. In an embodiment, when add icon 612 is selected in interface 600, add task interface 900 is displayed on display 262 of mobile device 160.

By using input device 264, a user can select title data entry field 944 and enter the task title value. In an embodiment, each task in synchronization system 100 comprises a plurality of data fields comprising task title 944. By selecting start by data entry field 946, a user can select the desired start date. In an embodiment of the invention, an interface similar to interface 1000 is launched to provide the user with a date ‘wheel’ to scroll through in order to select a value for start by data entry field 946. Similarly, a user can use input device 264 to enter due date data entry field 948 and completed date data entry field 950 to indicate the date the task is due and the date the task was completed, respectively.

Using input device 264, a user can select or tap complete data entry field 952 and then toggle an on/off button (not shown—similar to on/off button 1068 depicted in FIG. 10) to ‘off’ if the task is not yet completed. Alternatively, the user can select or tap an on button (not shown) if the task has been completed. In an alternative embodiment, a task can be marked as completed by selecting edit button 602 in interface 600 described above with reference to FIG. 6.

A user can select or tap priority data entry field 954 in order to enter a priority value for the task being created. In an embodiment of the invention, selection of priority 954 launches a priority selection interface (not shown) which enables the user to select from a discrete list of task priority levels. In an example embodiment, priority levels of None, High, Medium, and Low can be selected.

In accordance with an embodiment, a user, using input device 264, can select or tap notes data entry field 956 in order to add notes to the task. In an embodiment, a user, using input device 264, can enter notes for the task.

According to an embodiment, a user, using input device 264, can assign the new task a category by selecting category data entry field 958. According an embodiment, the user can select from a discrete list of pre-defined task categories stored in task database 166. In an alternative embodiment, the user can enter a category name for the task into category data entry field 958.

In an embodiment, after all desired data entry fields have been entered, a user can select done button 942 in add task interface 900 to save the new task and return to tasks interface 600. Alternatively, if the user selects cancel button 940, the new task will be discarded and tasks interface 600 will be displayed. As described above with reference to the embodiments depicted in FIGS. 1-4, after selecting done button 942, the plurality of task data fields input via add task interface 900 can be stored in task database 166 on mobile device 160.

FIG. 10 depicts a start and end interface 1000 which a user, using input device 264, can use to select an event duration. In the exemplary interface of FIG. 10, a user can use input device 264 to select starts data entry field 1062 and select the event starting month/day, hour, minutes, and AM/PM by using date scroll wheel 1070 depicted in the lower half of interface 1000. Similarly, the user can select ends data entry field 1064 and select the event ending month/day, hour, minutes, and AM/PM by using date scroll wheel 1070. Alternatively, if the user is creating an all-day event, all-day data entry field 1066 can be selected by toggling on/off button 1068 to ‘on.’

After the desired event duration has been selected, the user can complete the event creation process by selecting save button 1060.

### VI. Example Computer System Implementation

Various aspects of the present invention can be implemented by software, firmware, hardware, or a combination thereof. FIG. 11 illustrates an example computer system 1100 in which the present invention, or portions thereof, can be implemented as computer-readable code. For example, the methods illustrated by the flowcharts 300 and 400 of FIGS. 3 and 4 can be implemented in system 1100. Task synchronization systems 100 and 200 can also be implemented in system 1100. Various embodiments of the invention are described in terms of this example computer system 1100. After reading this description, it will become apparent to a person skilled in the relevant art how to implement the invention using other computer systems and/or computer architectures.

Computer system 1100 includes one or more processors, such as processor 1104. Processor 1104 can be a special purpose or a general purpose processor. Processor 1104 is connected to a communication infrastructure 1106 (for example, a bus, or network).

Computer system 1100 also includes a main memory 1108, preferably random access memory (RAM), and may also include a secondary memory 1110. Secondary memory 1110 may include, for example, a hard disk drive 1112, a removable storage drive 1114, flash memory, a memory stick, and/or any similar non-volatile storage mechanism. Removable storage drive 1114 may comprise a floppy disk drive, a magnetic tape drive, an optical disk drive, a flash memory, or the like. The removable storage drive 1114 reads from and/or writes to a removable storage unit 1118 in a well known manner. Removable storage unit 1118 may comprise a floppy disk, magnetic tape, optical disk, etc. which is read by and written to by removable storage drive 1114. As will be appreciated by persons skilled in the relevant art(s), removable storage unit 1118 includes a computer usable storage medium having stored therein computer software and/or data.

In alternative implementations, secondary memory 1110 may include other similar means for allowing computer programs or other instructions to be loaded into computer system 1100. Such means may include, for example, a removable storage unit 1122 and an interface 1120. Examples of such means may include a program cartridge and cartridge interface (such as that found in video game devices), a removable memory chip (such as an EPROM, or PROM) and associated socket, and other removable storage units 1122 and interfaces 1120 which allow software and data to be transferred from the removable storage unit 1122 to computer system 1100.

Computer system 1100 may also include a communications interface 1124. Communications interface 1124 allows software and data to be transferred between computer system 1100 and external devices. Communications interface 1124 may include a modem, a network interface (such as an Ethernet card), a communications port, a PCMCIA slot and card, or the like. Software and data transferred via communications interface 1124 are in the form of signals which may be electronic, electromagnetic, optical, or other signals capable of being received by communications interface 1124. These signals are provided to communications interface 1124 via a communications path 1126. Communications path 1126 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 1118, removable storage unit 1122, and a hard disk installed in hard disk drive 1112. Signals carried over communications path 1126 can also embody the logic described herein. Computer program medium and computer usable medium can also refer to memories, such as main memory 1108 and secondary memory 1110, which can be memory semiconductors (e.g. DRAMs, etc.). These computer program products are means for providing software to computer system 1100.

Computer programs (also called computer control logic) are stored in main memory 1108 and/or secondary memory 1110. Computer programs may also be received via communications interface 1124. Such computer programs, when executed, enable computer system 1100 to implement the present invention as discussed herein. In particular, the computer programs, when executed, enable processor 1104 to implement the processes of the present invention, such as the steps in the methods illustrated by flowcharts 300 of FIGS. 3 and 400 of FIG. 4 discussed above. Accordingly, such computer programs represent controllers of the computer system 1100. Where the invention is implemented using software, the software may be stored in a computer program product and loaded into computer system 1100 using removable storage drive 1114, interface 1120, hard drive 1112, or communications interface 1124.

The invention is also directed to computer program products comprising software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

### VII. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. It should be understood that the invention is not limited to these examples. The invention is applicable to any elements operating as described herein. Accordingly, the breadth and scope of the present invention should not be limited by any of the above-described exemplary embodiments, but should be defined only in accordance with the following claims and their equivalents.

What is claimed is:

1. A method for synchronizing tasks between a server having a task application and a mobile device lacking a native task application, the method comprising:
receiving from the server a plurality of data fields associated with a task;
transforming the plurality data fields into a document encoded according to a markup language, wherein the document is encoded according to an operating platform of the mobile device;
queuing the document if it is determined that the mobile device is offline; and
sending the document to the mobile device if it is determined that the mobile device is online.

2. The method of claim 1, wherein the mobile device runs an iPhone operating system.

3. The method of claim 2, wherein the mobile device is one or more of an Apple iPhone and an Apple iPod Touch.

4. The method of claim 1, further comprising displaying the plurality of data fields associated with the task at the mobile device using a user interface on the mobile device.

5. The method of claim 1, wherein the tasks include personal information manager (PIM) tasks.

6. The method of claim 5, wherein the PIM tasks include one or more of creating a meeting request, accepting meeting request, declining a meeting request, rescheduling an appointment, canceling an appointment, creating a task, assigning a task, and updating a task.

7. The method of claim 1, wherein the plurality of data fields comprise one or more of a title, start date, due date, completion status, duration, priority, notes, category, and status.

8. The method of claim 7 wherein the status data field values comprise deferred, not started, incomplete, overdue, in progress, recurring, and completed.

9. The method of claim 7, wherein the priority data field values comprise None, High, Medium, and Low.

10. The method of claim 1, wherein the markup language conforms to extensible markup language (XML).

11. The method of claim 1, wherein the server is one or more of a Microsoft Exchange server, a Lotus Domino server, a Lotus Notes server, and a Novell GroupWise server.

12. A tangible computer-readable medium having stored thereon, computer-executable instructions that, in response to execution by a computing device, cause the computing device to perform a method for method for synchronizing tasks between a mobile device lacking a native task application and a server having a task application installed therein, the method comprising:
receiving from the mobile device a plurality of data fields associated with a task;
storing, in a database, the plurality of data fields;
transforming the plurality data fields into a task record formatted according to the task application installed on the server; and
communicating, to the task application installed on the server, the task record.

13. The tangible computer-readable medium of claim 12, wherein the plurality of data fields associated with a task are received from the mobile device as a document encoded in a markup language.

14. The tangible computer-readable medium of claim 13, wherein the markup language conforms to extensible markup language (XML).

15. The tangible computer-readable medium of claim 13, the method further comprising parsing, prior to the storing, the markup language document in order to extract the plurality of data fields.

16. The tangible computer-readable medium of claim 13, the method further comprising detecting, prior to the receiving, one or more of a task update and a task creation occurring at the mobile device, wherein the task update and task creation is performed using a user interface on the mobile device.

17. A system capable of synchronizing tasks between a mobile device lacking a native task application and a server having a native task application installed therein, the system comprising:
a sync engine configured to receive an encoded document representing a task to be synchronized between the mobile device to the server, wherein the document is encoded in a markup language;
an adaptor module configured to parse the encoded document to extract a plurality of data fields from the encoded document, wherein the adaptor module is further configured to transform the encoded document into a task record formatted for the native task application;
a storage module configured to store the plurality of data fields in a data store; and
a transmission module configured to transmit the task record to the native task application.

18. The system of claim 17, wherein the mobile device runs the iPhone operating system.

19. The system of claim 17, wherein the encoded document represents one or more new tasks created on the mobile device.

20. The system of claim 17, wherein the encoded document represents one or more updated tasks edited on the mobile device.

21. A computer program product comprising a computer usable medium having computer program logic recorded thereon for enabling a processor to synchronize tasks from a task application to a plurality of mobile devices lacking native task applications, the computer program logic comprising:
listening means for enabling the processor to determine whether there is a task to be synchronized from the task application to the plurality of mobile devices;
a first receiving means for enabling the processor to receive the task to be synchronized;
adaptor means for enabling the processor to transform the received task into a document encoded according to a markup language;
caching means for enabling the processor to save the task to be synchronized in a request cache, wherein the request cache is accessible from the task application, wherein the request cache includes at least a unique record identifier identifying the received task;
determining means for enabling the processor to determine whether said one of the plurality of mobile devices is offline;
queuing means for enabling the processor to queue synchronization of said task for said task application in response to the determining means determining that said one of the plurality of mobile devices is offline;
transmission means for enabling the processor to transmit the document to said one of the plurality of mobile devices in response to the determining means determining that said one of the plurality of mobile devices is online;
a second receiving means for enabling the processor to receive task synchronization results from said one of the plurality of mobile devices after said task has been transmitted to said one of the plurality of mobile devices, wherein the task synchronization results include at least a task synchronization status and the unique record identifier identifying the task.
